(19) United States
(12) Patent Application Publication
(10) Pub. No.: US 2015/0117674 A1
(43) Pub. Date: Apr. 30, 2015

(54) DYNAMIC AUDIO INPUT FILTERING FOR MULTI-DEVICE SYSTEMS

(71) Applicant: Samsung Electronics Company, Ltd., Suwon City (KR)

(72) Inventors: Jason Meachum, Mission Viejo, CA (US); Michael Bringle, Irvine, CA (US); Esther Zheng, Irvine, CA (US); Can Gurbag, Irvine, CA (US)

(73) Assignee: Samsung Electronics Company, Ltd., Suwon City (KR)

(21) Appl. No.: 14/062,813

(22) Filed: Oct. 24, 2013

(51) Int. Cl. G10L 21/0208

(52) U.S. Cl. CPC G10L 21/0208; G10L 2021/02082
USPC 381/94.1

(57) ABSTRACT

A method for audio coordination. The method includes connecting electronic devices to a communication session. Distinct signals are assigned to each of the electronic devices. Input streams are established from one or more of the electronic devices. Signals are detected within the input streams. One or more electronic devices are selected for eliminating input streams based on an audio fidelity threshold.

### TECHNICAL FIELD

One or more embodiments relate generally to audio coordination, and in particular to dynamic audio coordination for connected devices.

### BACKGROUND

In a system of multiple networked devices where each device simultaneously transmits audio input and relays audio output from the other devices, if any of those devices are within audible range of another there are potential problems with reverberations and unwanted input waveform replication. Reverberations and unwanted input waveform replication issues can manifest as noise and distortions in the composite waveform being output by each device in the multi-device system.

### SUMMARY

In one embodiment, a method provides for audio coordination. One embodiment comprises connecting electronic devices to a communication session. In one embodiment, distinct signals are assigned to each of the electronic devices. In one embodiment, input streams are established from one or more of the electronic devices. In one embodiment, signals are detected within the input streams, and one or more electronic devices are selected for eliminating input streams based on an audio fidelity threshold.

Another embodiment provides a coordinator device that manages audio input for a plurality of connected client devices. In one embodiment, the coordinator device comprises a signal generator that generates and associates a distinct waveform for each connected client device, a signal detector that detects signal power and waveforms present within audio streams from the plurality of client devices, a signal analyzer that analyzes the detected waveforms and determines a particular client device that transmitted a detected waveform based on an associated waveform for the particular client device, and an input signal selector that selects one or more client devices to cease streaming input to peer client devices based on audio fidelity.

One embodiment provides a client device comprising a connection manager that manages connections to one or more peer devices joined in a communication session. In one embodiment, the client device includes a stream manager that manages audio streams including preparing audio streams for transmission or output, a mixer that combines multiple audio streams into a single audio stream, and a synchronizer that uses timing information embedded within the audio streams sent from other peer devices for synchronizing playback of the audio streams and increasing audio fidelity within an audible space for peer devices within close proximity to one another.

Another embodiment provides a non-transitory computer-readable medium having instructions which when executed on a computer perform a method comprising: connecting a plurality of electronic devices to a communication session. In one embodiment, distinct signals are assigned to each of the plurality of electronic devices. In one embodiment, input streams are established from one or more of the plurality of electronic devices. In one embodiment, signals are detected within the input streams, and one or more electronic devices are selected for eliminating input streams based on an audio fidelity threshold.

These and other aspects and advantages of the one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of a system architecture for audio coordination in a network, according to an embodiment.

FIG. 3 shows an example scenario for interconnected client devices, according to an embodiment.

FIG. 4 shows an example scenario of multiple interconnected devices in close proximity to one another, according to an embodiment.

FIG. 5 shows an example scenario for interconnected client devices with a central coordinator device, according to an embodiment.

FIG. 6A-D shows example scenarios for audio coordination, according to an embodiment.

FIG. 7 shows a block diagram for a central coordinator device, according to an embodiment.

FIG. 8 shows a block diagram for a client device, according to an embodiment.

FIG. 9 shows a flow diagram for a central coordinator process, according to an embodiment.

FIG. 10 shows a flow diagram for a client process, according to an embodiment.

FIG. 11 shows a block diagram for a peer coordination client device, according to an embodiment.

FIG. 12 shows a flow diagram for a peer coordination client process, according to an embodiment.

FIG. 13 shows a flow diagram for a client process, according to an embodiment.

FIG. 14 shows a block diagram for a centralized optimizer device, according to an embodiment.

FIG. 15 shows a block diagram for a client device, according to an embodiment.

FIG. 16 shows a flow diagram for a centralized optimizer process, according to an embodiment.

FIG. 17 shows a flow diagram for a client process, according to an embodiment.

FIG. 18 is a high-level block diagram showing an information processing system comprising a computing system implementing one or more embodiments.

### DETAILED DESCRIPTION

The following description is made for the purpose of illustrating the general principles of the one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to dynamic audio coordination of connected devices. In one embodiment, provides connection to an application launched within a network by electronic devices.

In one embodiment, the electronic devices comprise one or more mobile electronic devices capable of data communication over a communication link such as a wireless communication link. Examples of such mobile device include a mobile phone device, a mobile tablet device, etc. In one embodiment, a method provides for application connection for electronic devices in a network. One embodiment comprises receiving a list of application active sessions by a first electronic device based on location of the active sessions in relation to a location of the first electronic device. In one embodiment, an active session is selected using the first electronic device to gain access to a secured network for connecting to a first application by the first electronic device.

Another embodiment provides a method for application connection for electronic devices in a network that comprises receiving session information by a first device. In one embodiment, the first device includes a first application launched thereon. In one embodiment, an invitation message including the session information is provided to a second electronic device. In one embodiment, the session information is used by the second electronic device to connect to the first application.

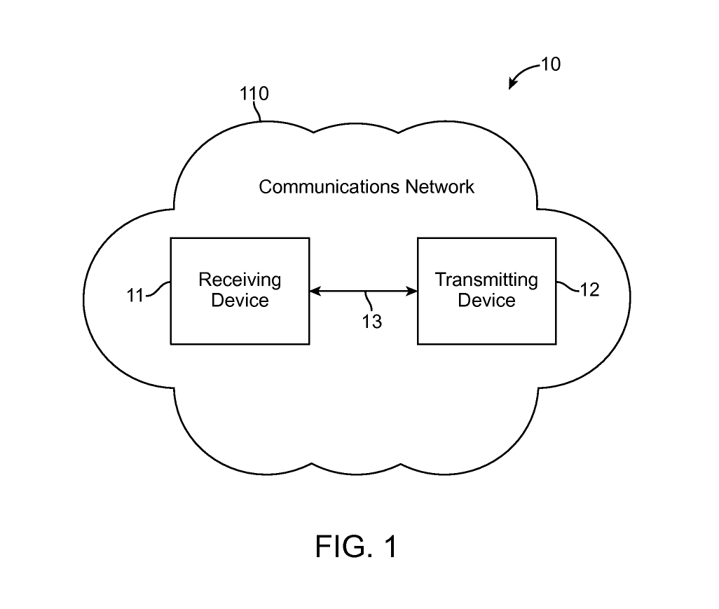

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a media player, a cellular telephone or a landline telephone, a personal e-mail or messaging device with audio and/or video capabilities, pocket-sized personal computers such as an iPAQ Pocket PC available by Hewlett Packard Inc., of Palo Alto, Calif., personal digital assistants (PDAs), a desktop computer, a laptop computer, and any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

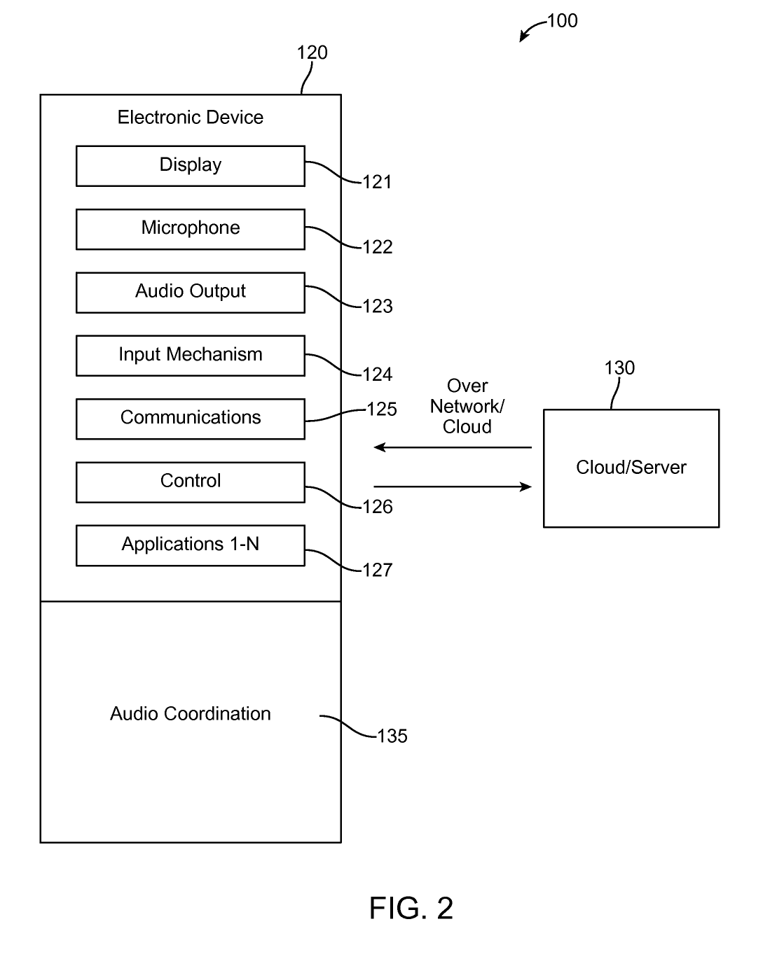

FIG. 2 shows a functional block diagram of an architecture system 100 that may be used for voice control of applications for an electronic device 120, according to an embodiment. Both transmitting device 12 and receiving device 11 may include some or all of the features of electronics device 120. In one embodiment, the electronic device 120 may comprise a display 121, a microphone 122, audio output 123, input mechanism 124, communications circuitry 125, control circuitry 126, a camera module 128 (e.g., one or more camera devices, etc.), an audio coordination module 135, and any other suitable components. In one embodiment, applications 1-N 127 are provided by providers (e.g., third-party providers, developers, etc.) and may be obtained from the cloud or server 130, communications network 110, etc., where N is a positive integer equal to or greater than 1. In one embodiment, the audio coordination module may be implemented on the cloud or server 130 for handling audio coordination functions for multiple electronic devices 120 (i.e., clients of the cloud or server 130).

In one embodiment, all of the applications employed by audio output 123, display 121, input mechanism 124, communications circuitry 125 and microphone 122 may be interconnected and managed by control circuitry 126. In one example, a hand held music player capable of transmitting music to other tuning devices may be incorporated into the electronics device 120.

In one embodiment, audio output 123 may include any suitable audio component for providing audio to the user of electronics device 120. For example, audio output 123 may include one or more speakers (e.g., mono or stereo speakers) built into electronics device 120. In some embodiments, audio output 123 may include an audio component that is remotely coupled to electronics device 120. For example, audio output 123 may include a headset, headphones or earbuds that may be coupled to communications device with a wire (e.g., coupled to electronics device 120 with a jack) or wirelessly (e.g., Bluetooth® headphones or a Bluetooth® headset).

In one embodiment, display 121 may include any suitable screen or projection system for providing a display visible to the user. For example, display 121 may include a screen (e.g., an LCD screen) that is incorporated in electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset, TCP/IP components using network interface controllers (NICs), etc.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app). In some embodiments, the electronics device 120 may include one or several applications operative to perform communications operations. For example, the electronics device 120 may include a messaging application, a mail application, a voicemail application, an instant messaging application (e.g., for chatting), a videoconferencing application, a fax application, a voice over Internet protocol (VoIP) application, a karaoke application, or any other suitable application for performing any suitable communications operation.

In some embodiments, the electronics device 120 may include microphone 122. For example, electronics device 120 may include microphone 122 to allow the user to transmit audio (e.g., voice audio) for speech control and navigation of applications 1-N 127, during a communications operation or as a means of establishing a communications operation or as an alternate to using a physical user interface. Microphone 122 may be incorporated in electronics device 120, or may be remotely coupled to the electronics device 120. For example, microphone 122 may be incorporated in wired headphones, microphone 122 may be incorporated in a wireless headset, may be incorporated in a remote control device, etc.

In one embodiment, the electronics device 120 may include any other component suitable for performing a communications operation. For example, the electronics device 120 may include a power supply, ports or interfaces for coupling to a host device, a secondary input mechanism (e.g., an ON/OFF switch), or any other suitable component.

In one embodiment, the audio coordination module 135 provides either relies on other client devices or a centralized system or coordinator to which the electronic device 120 and other client devices are connected to determine which single device within an audible space provides the best audio reproduction of that space. In one embodiment, when an electronic device 120 has been identified all other electronic devices 120 within that space will disable their inputs using the audio coordination module 135. In one embodiment, the audio coordination module of electronic devices 120 assists to continuously determine relative proximity to other connected electronic devices 120 (i.e., peer client devices) in addition to assisting in determining which would provide the best audio capture.

Using a microphone in close proximity to speakers intended to output the input of that microphone may result in the effect of reverberation, which rapidly distorts the waveform into a high frequency screech due to a feedback loop. Similarly, callers to radio programs often cause audio noise and interference for the broadcast if they do not turn down their radio before they go on air. Additionally, any situation where multiple microphones are in close proximity to one another and connected to the same system may create echoes and noise in such a system, such as multiple people on the same conference call but on different phones.

In all of the aforementioned scenarios the conventional solutions have been straightforward, such as removing problematic input receivers, placing each input receiver out of audible range of the others, or having the system intentionally filter out known waveforms from the input itself. In the first case where the microphone will be in close proximity to speakers, the most effective solution would be to filter out known waveforms in conjunction with strategic positioning of the speakers, as is done in concerts and public announcement systems. A stage technician will purposefully tune the system to essentially try and band-pass only the speaker's voice. It also helps that the microphone used in those situations is purposefully directional, only accepting input that is directly in front of the receiver. When radio hosts become aware of any feedback issues or noise in their broadcast after taking a caller they will immediately ask that caller to turn their radio down. For the case of conference callers, the users may congregate around a single input device via speaker-phone or go into separate rooms with their own devices. Some systems have multiple microphones per unit and in that case the system may actively filter duplicated inputs that otherwise would have manifested as noise.

All of the above-mentioned solutions require that either the users of each device or each device themselves be aware of every input of the system. Users are normally quite adept at identifying and rectifying system noise because they are cognizant of all the inputs into the system. Noise cancellation technology works at a device level because the device may utilize its auxiliary inputs to adjust the final waveform that is ultimately sent out to the system. However, none of the conventional solutions have a multi-device (where each device is independent of the others and not just a peripheral for another) or system level solution that actively coordinates between devices.

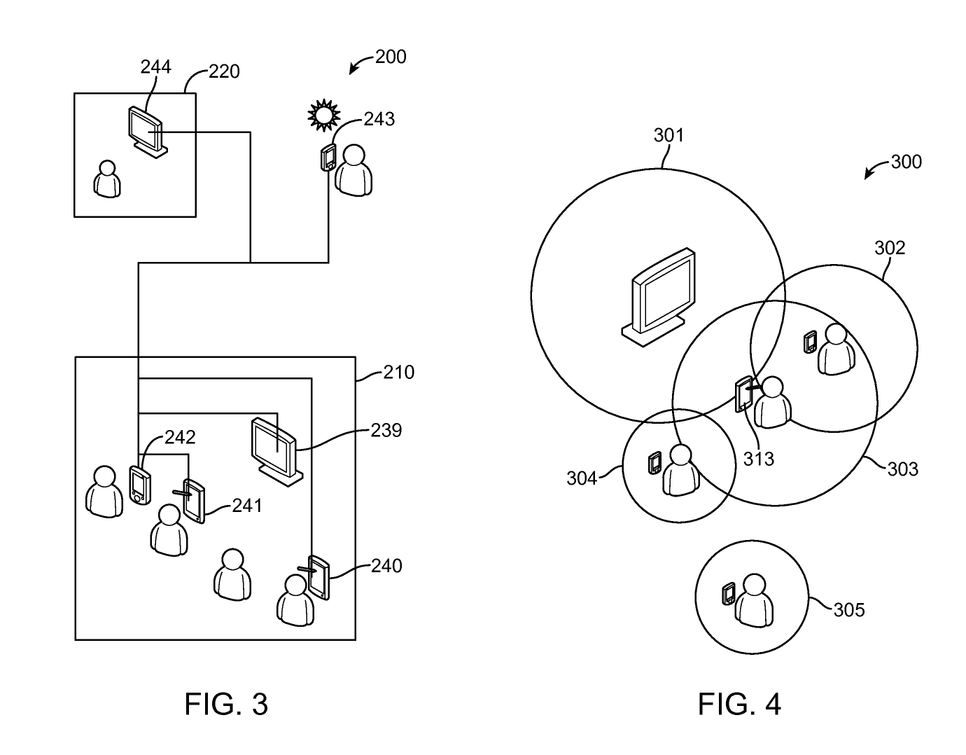

FIG. 3 shows an example scenario for interconnected client devices, according to an embodiment. In one embodiment, the interconnected client devices 239-244 may comprise electronic devices 120. In one embodiment, an audible space may comprise a room, enclosure, etc. where there are many different independent devices of varying capabilities, such as televisions, tablets, smart phones, computing devices, wearable devices, etc., which are interconnected via an audio coordination module 135 (FIG. 2) that may comprises client software or processing devices that share audio from each device within the audible space.

In one embodiment, the scenario 300 shows the client device 244 in the audible space 220, and client devices 239-242 in audible space 210. It should be noted that there may potentially be multiple users per client device 239-244 and that some devices may be within close proximity to one another. In one embodiment, the client devices that are enclosed in a rectangular box (e.g., 210 and 220) are considered to be within the same room as one another and thus in the same audible space.

In one embodiment, in the example scenario 200, the client devices 239-244 work together using the audio coordination module 135 to coordinate an effective solution to the aforementioned issues that occur with audio when multiple devices that share audio input and output are within close proximity to one another. In one embodiment, the audio coordination module 135 may be implemented in software, hardware, firmware, etc. and distributed across many clients, which utilize the detection of known audio signals in conjunction with other factors to determine which devices of the system share the same audible space and then coordinate an effective solution to the issues that would have otherwise manifested in that space.

In one embodiment, utilize the detection of known audio signals in conjunction with other factors to determine which devices of the system share the same audible space and then coordinate an effective solution to the issues that would have otherwise manifested in that space. In one embodiment, the known audio signals may be out of the human hearing range of detection. In one embodiment, the client devices 239-244 work together using an established protocol, to dynamically and continuously determine if they are within audible range of other devices. In one embodiment, in a deterministic pattern or sequence, each client device 239-244 emits a known audio signal. If other client devices are able to identify the known audible signal, then they are within range of the device that is currently emitting the known signal and the client devices work together to coordinate an appropriate solution for that audible space (e.g., audible space 210).

In one embodiment, it is established which client device (e.g., a client device 239-244) is capable of representing the audible space (e.g., audible space 210, 220) with the best fidelity for the audio that needs to be captured (e.g. sounds/speech generated by users themselves). In one embodiment, the device with the best fidelity would ideally be the device that has the highest relative input powers for the known audio signals emitted by client devices when compared to the other client devices in the same audible space. In one embodiment, the device with the best fidelity may likely be a client device in the middle of the audible space and therefore the best suited to capture the audio generated within that space. In one embodiment, once the device with the best fidelity is identified, all other client devices will cease taking audio input.

FIG. 4 shows an example scenario 300 of multiple interconnected client devices in close proximity to one another, according to an embodiment. For the sake of simplicity with regards to the scenario 300, the range with which each device may detect audio is equivalent to the range of its audio output and is represented by an appropriately shaded circle surrounding each client device. The shaded regions represent an ‘audible space’ for that device. Therefore, overlapping regions convey the fact that the client devices will interfere with each other when serving as inputs to the same system in that they will not only have duplicate inputs but also cause reverberations.

In one embodiment, in scenario 300, three users with their audible spaces 302, 303 and 304 are positioned in front of a TV that is in audible space 301, where each user has their own handheld client device. A fourth user and their client device in audible space 305 is nearby but not in the immediate vicinity as the others. The audible space 303 intersects audible space 301, 302 and 304 and acts as a bridge between those audible spaces as far as the system is concerned. Therefore, it may be asserted that a single ‘audible space’ is defined by the set of all contiguously overlapping regions. Within an ‘audible space’ one embodiment identifies a single client device to act as the sole input and to do so on a regular basis, dynamically assigning the responsibility for being the sole input for the audible space on a regular basis.

In one embodiment, the client device chosen to act as the sole input should be the device most capable of capturing all the inputs present in that audible space. In one embodiment, a deterministic process identifies which client device satisfies that requirement based on the detected relative powers of the aforementioned audio signals being emitted from each client device of the system. In one embodiment, the client device with the highest relative input powers when detecting the emitted signals of other client devices in the audible space may be considered to be the best candidate for serving as the sole audio input for that audible space. In the example scenario 300, it is reasonable to assume that this would be the client device 313 in the audible space 303, as client device 313 has the least distance between any other users and their respective devices for the audible space 303.

In one embodiment, the audio coordination module 135 determines which device shall serve as the sole input as follows: for each client device, the coordination module 135 determines the reference power level to be used for calculations. In one embodiment, the determination of the reference power level may be achieved by taking the root mean square (RMS) for all frequency powers present in an input sample, prior to the emission of signals by other client devices of the system. In one embodiment, because of changes in background and ambient noise, the reference power level may be re-determined periodically (e.g., time based, signal based, etc.).

In one embodiment, the audio coordination module 135 of each client device in the system begins to emit an assigned or associated distinct signal that is known by all other devices in close proximity, as determined by the system (e.g., by the client devices). In one embodiment, each device determines the decibel level of all the known signals being emitted by other client devices. By definition the decibel is a logarithmic unit that describes a ratio, and in one embodiment, that ratio is the ratio between the detected power of a given signal and that of the reference power level.

In one embodiment, the audio coordination module 135 of client devices use a deterministic process based on the detected decibel values that, when all client devices communicate their respective values to one another, identifies which client devices shall serve as the sole inputs for their respective audible spaces. In one embodiment, the process used is absolutely deterministic when all client devices coordinate together without using a central coordinator or server.

In one embodiment, once a client device has been chosen to serve as the sole input for the audible space, all other client devices of the same space mute their inputs (e.g., microphone 122). In one embodiment, a client device serving as the input only transmits that input to client devices outside of its own audible space, to prevent reverberations and feedback by the other client devices within its own audible space.

In one embodiment, users are presented with a visual cue (e.g., flashing screen, flashing light from a camera flash, etc.) by the client (device) of their client device that conveys which device within the audible space is currently acting as the input to the system. In one embodiment, the visual cue allows for the scenario where a user may be on the fringe of the audio input capabilities of the chosen client device for the audible space and therefore will be hard to hear for users in other audible spaces. Much like users of any contemporary conference call system, they should readily adapt to the situation in order to be received by the system: either they will move farther away from the space to create their own space or they will move closer to the device currently serving as the input in order to be received by it.

In one embodiment, the same deterministic process that is used to determine which client device should serve as the sole input for a given audible space may also be employed to determine which client device should serve as the sole audio output for that audible space but, with a fundamental difference. In one embodiment, instead of determining which client device is most capable of detecting the largest set of emitted signals from other client devices, the deterministic process determines which client device is capable of having its signal detected by the most client devices of the audible space in terms of having the highest relative power across all or most client devices of that audible space. In scenario 300, it is reasonable to assume that this would be the device in audible space 303, as it has the largest output range (represented by the diameter of the circle) and overlaps the input receiving capability of the most client devices (again, assuming that scenario 300 represents both input and output by the same surrounding circle).

In one embodiment, audio quality as a qualitative metric plays an important factor for the end user experience and device type with relation to that metric and has a weight in the device determination process as well. It is easily argued that the audio output quality of a TV should have a much higher frequency range and fidelity than the speakers of a mobile device. As with the determination of the audio input device, in one embodiment the determination for which client device shall serve as the sole system output is dynamic.

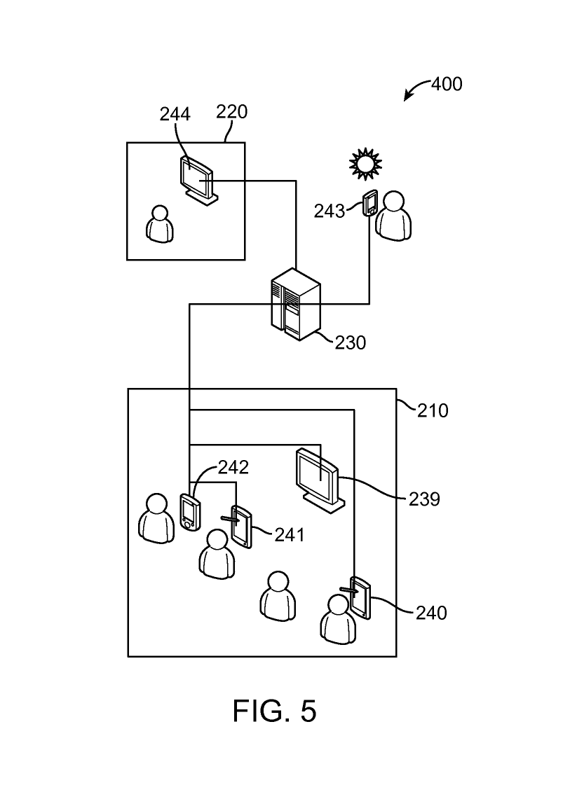

FIG. 5 shows an example scenario 400 for interconnected client devices (devices 239-244) with a central coordinator, server device or cloud server/environment 230, according to an embodiment. In one embodiment, the all client devices 239-244 in the example scenario 300 are connected to the coordinator device 230 that coordinates the client devices 239-244. In one embodiment, the client devices emit known distinct signals that are assigned or determined by the coordinator device 230.

In one embodiment, each client device 239-244 transmits its audio input to the coordinator device 230. In one embodiment, the coordinator device 230 is responsible for analyzing each input from each client device 239-244, digitally filters out duplicate signals, and relays the final cleansed output to the appropriate client device 239-244 for optimized audio. In one embodiment, the coordinator device 230 uses the knowledge of what each client device 239-244 is emitting and receiving to reduce each signal to an idealized form based on waveform cancellation techniques and device identification based on the assigned distinct signal.

In one embodiment, an audio coordination process is used to synchronize the waveforms of each device to one another, using discrete markers within the device signals, such that waveform cancellation is most effective.

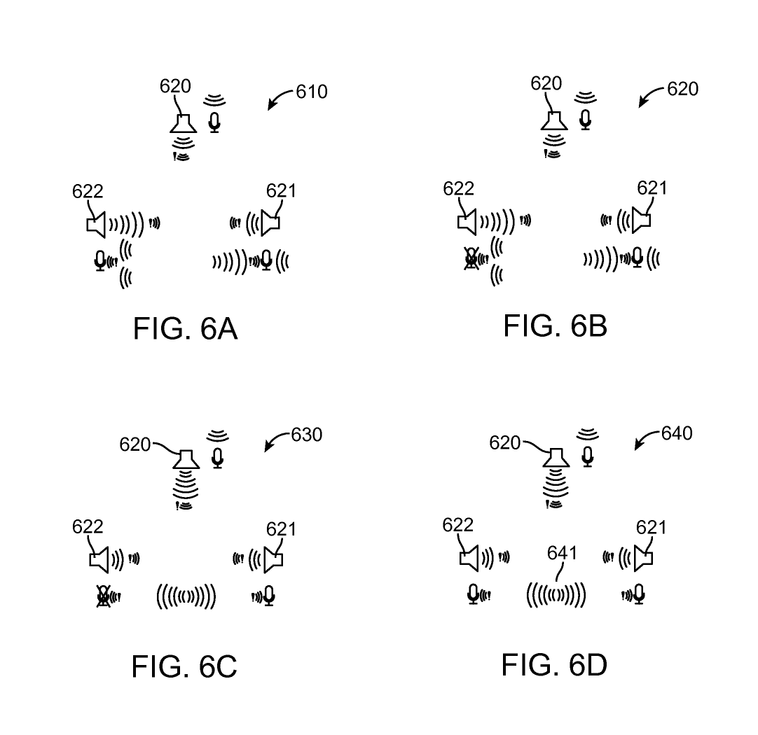

FIG. 6A-D shows example scenarios for audio coordination, according to an embodiment. In one embodiment, to mitigate the aforementioned audio issues (e.g., noise, reverberation, etc.) the system handles the audio inputs in a coordinated and deterministic manner, with the goals of maintaining audio fidelity of the inputs to each client device and excluding extraneous audio from the output of certain devices in the system. In one embodiment, the audio coordination is processed in real time and with the intent to reproduce the respective audible spaces that each client device inhabits.

In on example embodiment, in FIGS. 6A-D the signals intended to be used for identifying device sources are represented by an audio icon with an exclamation point in front of it. FIG. 6A shows an example embodiment scenario where the client devices 620-622 themselves determine which single client device within an audible space provides the best audio reproduction of that audible space. In the example embodiment scenario 610, the client devices 620, 621 and 622 emit their assigned distinct signal while each device listens. In scenario 610, it may be seen that client device 620 emits its distinct signal and hears its distinct signal, but does not hear the distinct signals from client devices, while client devices 621 and 622 may hear each other's distinct signal.

FIG. 6B shows the example embodiment scenario 620 where upon a client device that has been identified all other devices within that space disables their inputs. In scenario 620 client device 622 has disabled its input. In one embodiment, client devices continuously determine their relative proximity to one another in addition to determining which would provide the best audio capture.

FIG. 6C shows the example embodiment scenario 630, where it is assumed that the client device 621 is best suited to capture the shared audible space that it occupies with the client device 622, and maintaining the assumption that the client device 610 is isolated. In one embodiment, the client device 622 disables its input and stops outputting the audio from the client device 621. The result is that all inputs for the shared space are considered to be from the client device 622 and client device 621 users simultaneously, as represented by the combined signals between the client device 622 and client device 621, and only the client device 621 is taking input.

FIG. 6D shows the example embodiment scenario 640 that uses a centralized coordinator device or server. In one embodiment, all of the client devices 620-622 are connected to a centralized coordinator device or server. In one embodiment, the centralized coordinator device may be one of the client devices 620-622 among the interconnected devices. In one embodiment, the centralized coordinator determines and filters out duplicated waveforms before delivering composite waveforms 641 to be output by the appropriate respective client devices. In one embodiment, the centralized coordinator accomplishes this by knowing the origins of each waveform and it subtracts duplicates from the final composite, using the knowledge of which devices were within the same audible space as one another to assist in determining which waveforms were indeed duplicated.

In one embodiment, coordination between the client devices or coordination using a centralized coordinator benefits from audio output synchronization. That is to say, because the devices may be in close proximity to one another, any variance in the output of audio would be very noticeable between those devices. It would be reasonable to posit that differences in network propagation of the audio to the devices would be the primary factor for this delay. In one embodiment, any offset between the outputs of devices that are within close proximity to one another are reduced to improve the end user experience.

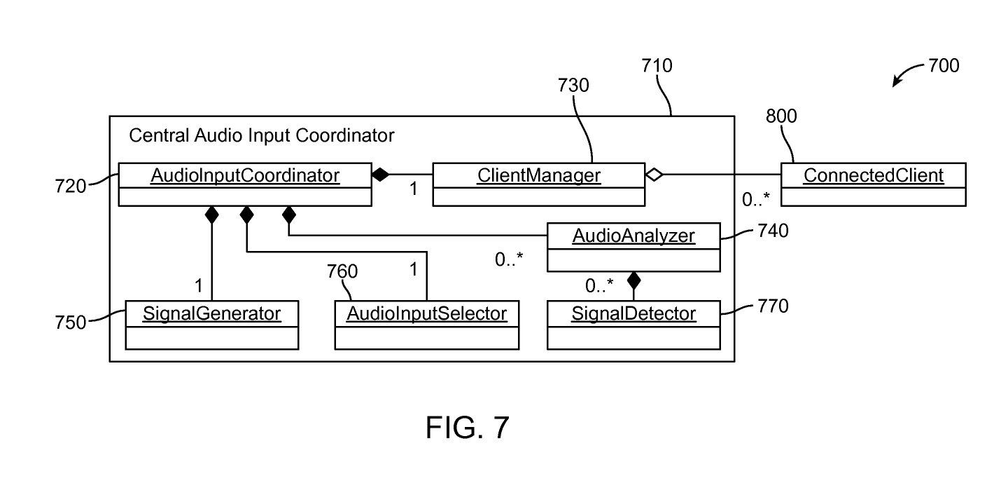

FIG. 7 shows a block diagram for system 700 with a centralized coordinator device or server 710 that is connected by client devices 800, according to an embodiment. In one embodiment, the central coordinator device 710 includes an audio input coordinator module 720, a client manager module 730, an audio analyzer 740, a signal generator 750, an audio input selector 760 and a signal detector 770. In one embodiment, in system 700 the client devices 800 rely on the centralized coordinator device 710 using the audio input coordinator 720. In one embodiment, the audio input coordinator 720 uses the client manager module 730, the audio analyzer 740, the signal generator 750, the audio input selector 760 and the signal detector 770 to determine which client device 800 should have their audio inputs (i.e., audio captured by their microphones 122, FIG. 2) streaming to their respective peer devices.

In one embodiment, the client manager 730 manages network connections to client devices 800, and handles message passing and encryption. In one embodiment, the signal generator 750 generates a distinct and distinguishable waveform for each connected client device 800 instance (e.g., associates a distinct waveform for each client device 800). In one embodiment, the waveform is transmitted to a particular client 800 so that it can mix it into the audio that the particular client 800 outputs. In one embodiment, the audio input coordinator 720 keeps track of the distinct signal-to-client device 800 mapping. In one embodiment, these distinct signals and their associated clients 800 are used to determine the discrete ‘audible spaces’ that each client device 800 belongs to.

In one embodiment, the signal detector 770 detects signals present in audio streams and their relative power. In one embodiment, given an audio stream and a set of known signals (generated by the signal generator 750, the signal detector 770 is able to detect if those signals are present within the audio streams and at what relative power. In one embodiment, the audio analyzer 740 may be replicated for each connected client 800, where each audio analyzer 740 performs concurrent analysis through utilization of signal detector 770 instances. In one embodiment, the audio analyzer 740 provides a process for asynchronously notifying the audio input coordinator 720 of any detected signals identified in an audio stream.

In one embodiment, upon notification by the audio analyzer 740 that known signals have been detected in the client audio streams, the audio input coordinator 720 uses the audio input selector 760 to determine which client should cease streaming its input to its peer devices for the sake of audio fidelity. In one embodiment the audio input selector 760 shall a determination for client devices 800 to cease streaming based upon which client signals have been detected upon the inputs of other clients, and their relative signal strengths.

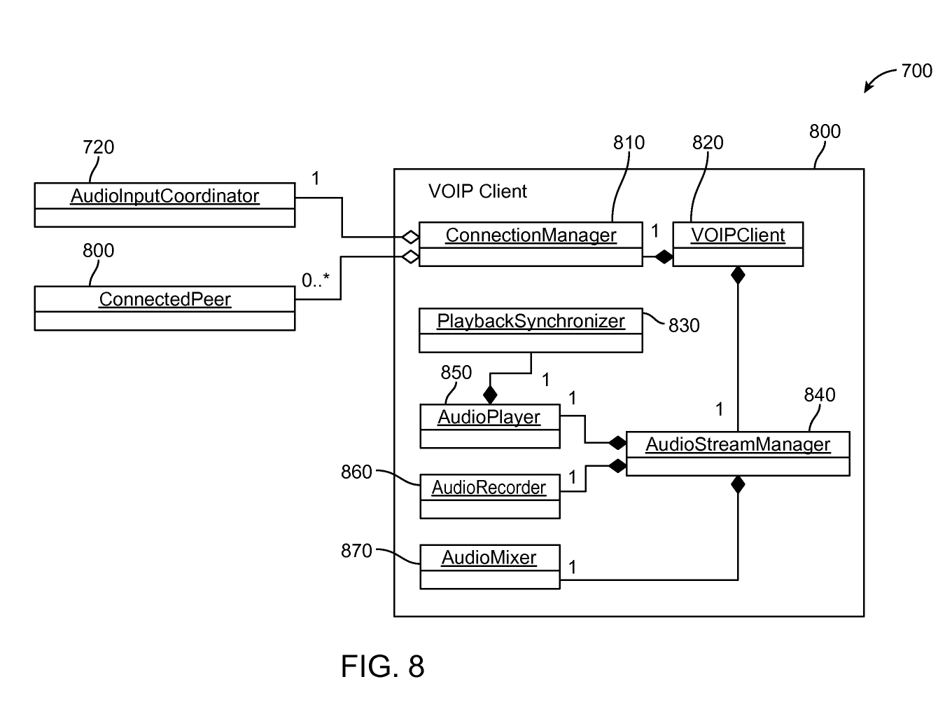

FIG. 8 shows a block diagram for a client device 800 of system 700, according to an embodiment. In one embodiment, each client 800 is connected with the audio input coordinator 720 (of the central audio coordinator device 710) as well as its respective peer devices (i.e., other client devices 800) upon starting an audio session, such as a VOIP session, a karaoke session, a recording session, etc. In one embodiment, the client device 800 includes a connection manager module 810, a VOIP client module 820, a playback synchronizer module 830, an audio stream manager module 840, an audio player module 850, an audio recorder module 860 and an audio mixer module 870.

In one embodiment, the connection manager module 810 manages network connections to peer devices (e.g., client devices 800) and the audio input coordinator module 720, handles message passing and encryption. In one embodiment, the audio stream manager module 840 manages the various audio streams that must be handled by the client device 800, and prepares the audio streams for transmission or speaker output accordingly.

In one embodiment, the audio mixer module 870 handles the combining of multiple audio streams into a single stream. In one embodiment, the audio recorder module 860 provides the audio input stream for the client device 800. In one embodiment, the audio player module 850 handles output of audio streams from the client device 800. In one embodiment, the audio player module 850 utilizes the playback synchronizer module 830 to ensure playback is coordinated with other client devices 800 within the audible space.

In one embodiment, the playback synchronizer module 830 uses timing information embedded within the audio streams sent from other client devices 800 to synchronize the playback of those streams. This will increase the perceived audio fidelity within an audible space for client devices 800 that are within close proximity to one another, but would otherwise be affected by network latency causing offsets in audio playback.

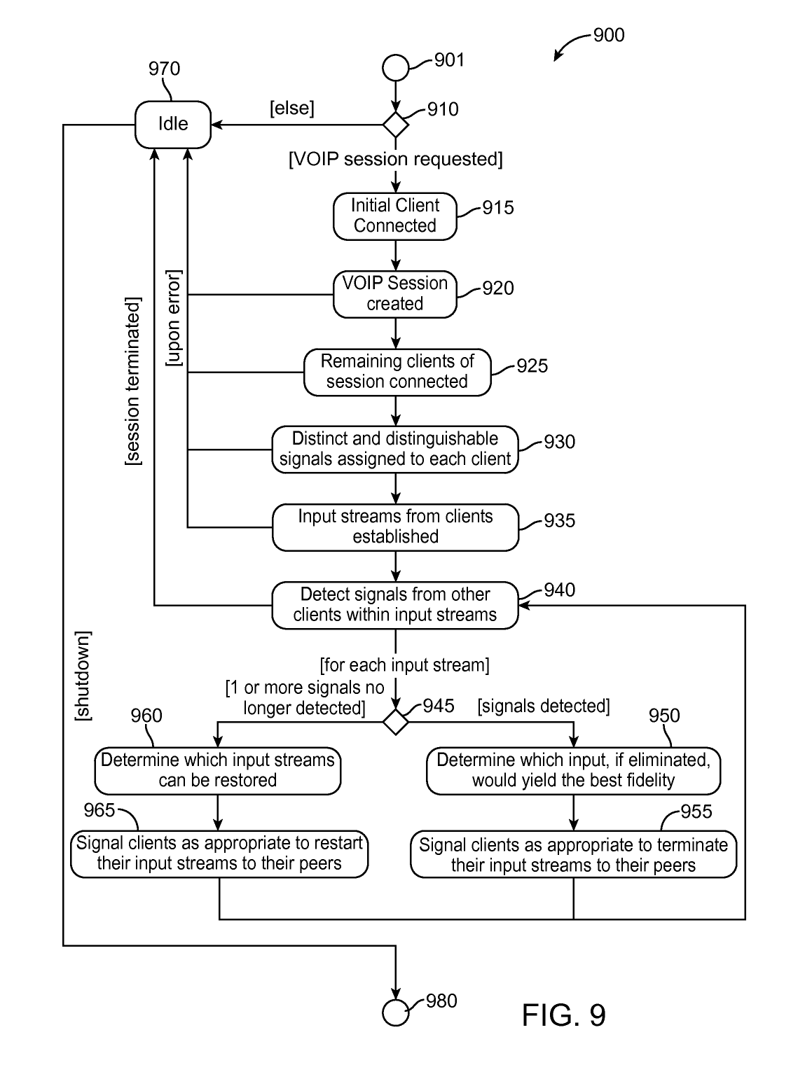

FIG. 9 shows a flow diagram for a central coordinator process 900, according to an embodiment. In one embodiment, process 900 starts at starting point 901 where a centralized coordinator device or server (e.g., coordinator device 710) starts up. In one embodiment, in block 910 an audio session (e.g., VOIP session, karaoke session, audio recording session, etc.) is requested by a client device (e.g., a client device 800). Otherwise, the process continues to idle at block 970 waiting for an audio session request. In block 915, an initial client device is connected with the centralized coordinator device. In one embodiment, in block 920, an audio session is created for the initial client device. In one embodiment, if an error starting an audio session occurs (e.g., transmission exception, network failure, etc.), process 900 continues to block 970 and either terminates process 900 at stop point 980 or remains idle waiting for a new request.

In one embodiment, in block 925, any remaining client devices that desire to connect to the audio session are connected by the centralized coordinator device. In one embodiment, if an error occurs, process 900 continues to block 970. In one embodiment, process 900 continues to block 930 where distinct and distinguishable audio signals are assigned/associated with each connected client device. In one embodiment, if an error occurs, process 900 continues to block 970.

In one embodiment, in block 935 input streams from clients are established. In one embodiment, if an error occurs, process 900 continues to block 970. In one embodiment, in block 940 signals are detected from clients within the input streams to determine the client device source of the input stream. In one embodiment, if an error occurs, process 900 continues to block 970. In one embodiment, in block 945, it is determined whether signals are detected or no longer detected from the input streams. In one embodiment, if one or more signals are no longer detected, process 900 continues to block 960, otherwise if signals remain detected, process 900 continues to block 950.

In one embodiment, in block 950, the centralized coordinator device determines which input stream, if eliminated, would yield the best audio fidelity. In one embodiment, process 900 continues to block 955, where clients are signaled as appropriate to terminate their input streams to the peer client devices (as determined in block 950). In one embodiment, in block 960, the centralized coordinator device determines which input stream can be restored. In one embodiment, in block 965, the centralized coordinator device signals the client devices as appropriate to restart their input streams to their peer client devices as determined in block 960. In one embodiment, after either block 955 or 965 completes, process 900 returns to block 940 to dynamically and continuously continue audio signal coordination.

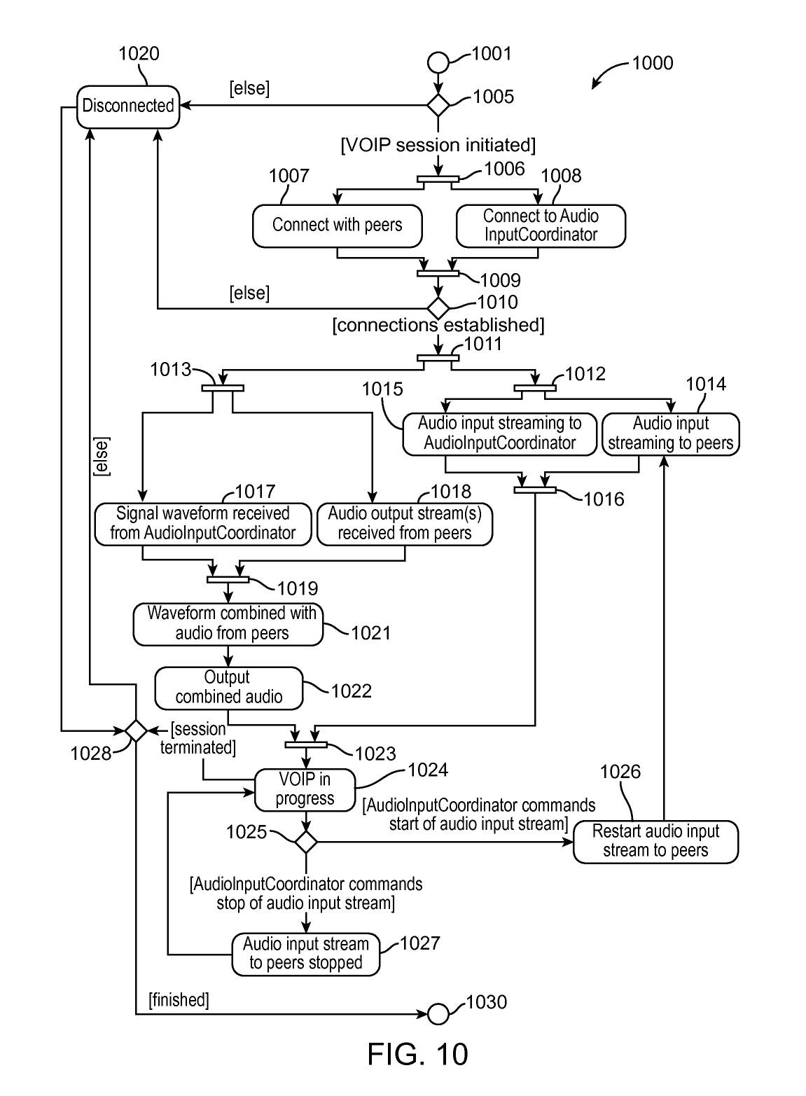

FIG. 10 shows a flow diagram for a client process 1000, according to an embodiment. In one embodiment, client process starts at starting point 1001 where a client device (e.g., client device 800) starts up. In one embodiment, in block 1005 an audio session (e.g., VOIP session, karaoke session, audio recording session, etc.) is initiated between a client device and a centralized coordinator device (e.g., centralized coordinator device or server 710). In block 1006, process 1000 parallel processes in block 1007 to connect with peer client devices and in block 1008 to connect with an audio input coordinator (e.g., audio input coordinator 720) of the centralized coordinator device. In one embodiment, process 1000 completes blocks 1007 and 1008 at block 1009, and continues to block 1010 where it is determined whether a connection has been established or not.

In one embodiment, if a connection is established in block 1010, process 1000 continues to block 1011, otherwise process 1000 continues to block 1020 where the status of the client device is updated to disconnected and the process may then proceed to block 1028. In block 1011, the process 1000 is split to process at blocks 1012 and 1013 in parallel. In one embodiment, in block 1014 audio input streams are streamed to peer client devices. In one embodiment, in block 1015, the audio input streams are streamed to the audio input coordinator of the centralized coordinator device. In one embodiment, the process 1000 continues to block 1016, where the process continues to block 1023 where the input streams and output streams are further processed.

In one embodiment, from block 1013, process 1000 continues to block 1017 and 1018. In one embodiment, in block 1017 a signal waveform is received from the audio input coordinator of the centralized coordinator device. In block 1018, audio output streams are received from client peer devices. In one embodiment, the process 1000 continues to block 1019, where the processing of blocks 1017 and 1018 are combined. In one embodiment, in block 1021 a waveform is combined with audio from peer client devices, and the output of combined audio results in block 1022.

In one embodiment, in block 1024, after processing of the input streams (from block 1016) and output streams (block 1022) are completed, process 1000 has achieved a status of an audio session in progress. In one embodiment, if the client device stops the audio session, process 1000 continues to block 1028 and the process 1000 continues to either block 1020 where the client device is disconnected (and then continues to block 1028) or to process stop point 1030. In one embodiment, the process 1000 otherwise continues to block 1025 where either the audio input coordinator of the centralized coordinator device commands start of an audio input stream or commands stopping of an audio input stream.

In one embodiment, if the audio input coordinator of the centralized coordinator device commands start of an audio input stream, process 1000 continues to block 1026 where audio input is restarted to the peer client devices, and process 1000 continues then to block 1014. In one embodiment, where the audio input coordinator of the centralized coordinator device commands stopping of an audio input stream, process 1000 continues to block 1027 where audio input streams to peer client devices are stopped, and process 1000 continues to block 1024.

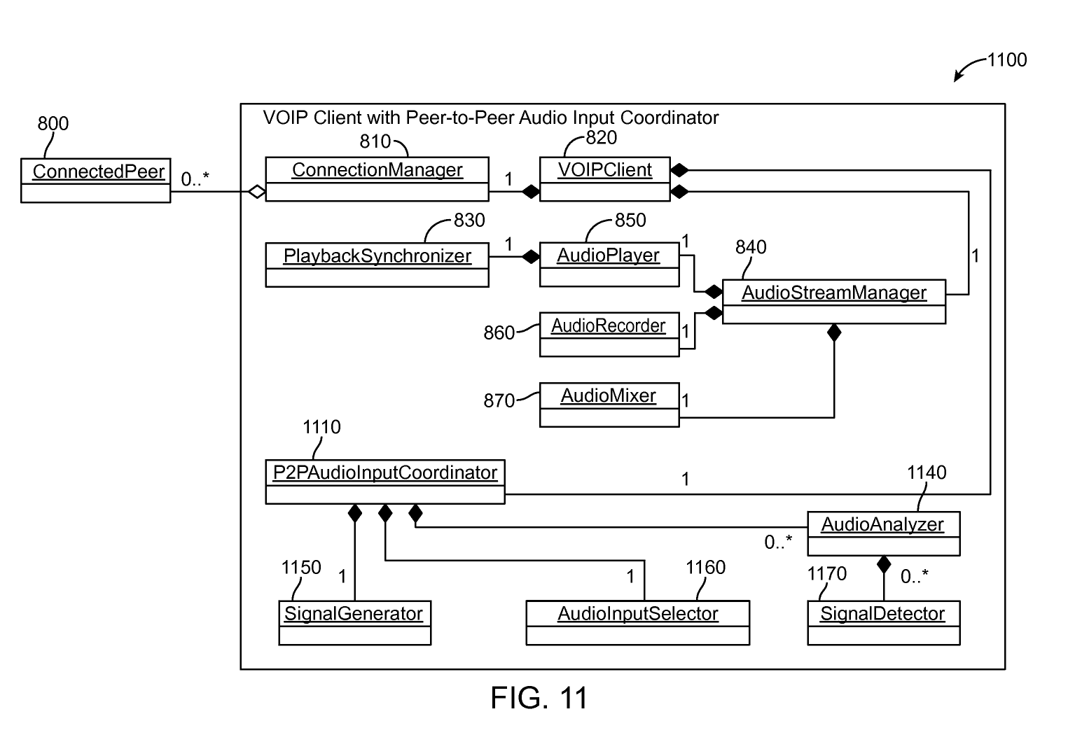

FIG. 11 shows a block diagram for a peer coordination client device 1100, according to an embodiment. In one embodiment, the peer coordination client device is similar to client device 800 with the following components: connection manager module 810, VOIP client module 820, playback synchronizer module 830, audio stream manager 840, audio player 850, audio recorder 860 and audio mixer 870. In one embodiment, the peer coordinator client device 1100 includes a P2P audio input coordinator module 1110, an audio analyzer module 1140, a signal generator module 1150, an audio input selector module 1160 and a signal detector module 1170.

In one embodiment, the P2P audio input coordinator module 1110 provides similar functionality as the audio input coordinator module 720 (FIG. 7). In one embodiment, the audio analyzer module 1140 provides similar functionality as the audio analyzer module 740 (FIG. 7). In one embodiment, the signal generator module 1150 provides similar functionality as the signal generator module 750 (FIG. 7). In one embodiment, the audio input selector module 1160 provides similar functionality as the audio input selector module 760 (FIG. 7). In one embodiment, the signal detector module 1170 provides similar functionality as the signal detector module 770 (FIG. 7).

In one embodiment, using the peer coordination client device 1100 removes the centralized coordinator in favor of a peer-to-peer coordination protocol, conducted at runtime by the P2P audio input coordinator module 1110. In one embodiment, essentially all responsibilities of the audio input coordinator module 720 (FIG. 7) is distributed across all clients and a deterministic process for detecting other clients, defining an audible space, and selectively disabling certain input streams to enhance audio fidelity is implemented. In one embodiment, because of potential constraints with regards to the processing power of the client devices (e.g., client devices 800/1100), a protocol is implemented to have each client device 800/1100 only be responsible for analyzing a subset of the total number of streams at any given time while still preserving system effectiveness.

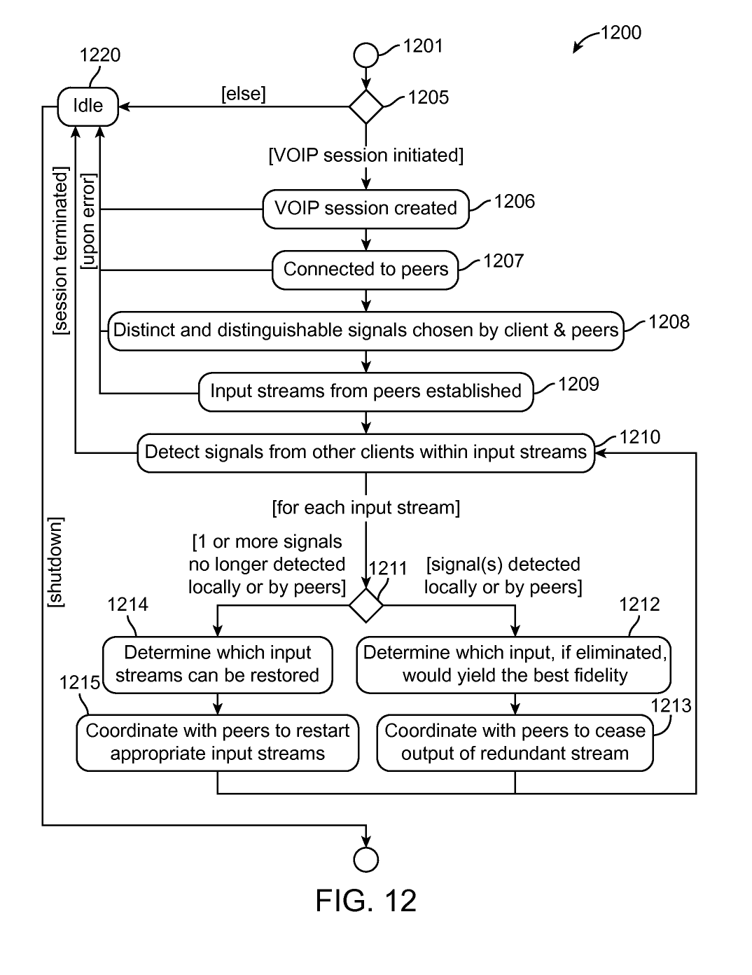

FIG. 12 shows a flow diagram for a peer coordination client process 1200, according to an embodiment. In one embodiment, process 1200 starts at starting point 1201 where a peer coordination client device (e.g., peer coordination client device 1100) starts up. In one embodiment, in block 1205 an audio session (e.g., VOIP session, karaoke session, audio recording session, etc.) is initiated by the peer coordination client device. Otherwise, the process 1200 continues to idle at block 1220 waiting to initialize an audio session request or terminate. In block 1206 an audio session is created, otherwise, if an error occurs (e.g., transmission exception, network failure, device failure, etc.), process 1200 continues to block 1220. In block 1207, the peer coordination device is connected to peer client devices, otherwise, if an error occurs, process 1200 continues to block 1220.

In one embodiment, process 1200 continues block 1208 where distinct and distinguishable audio signals are assigned/associated with each connected peer client device, otherwise, if an error occurs, process 1200 continues to block 1220. In one embodiment, in block 1209 input streams from clients are established, otherwise, if an error occurs, process 1200 continues to block 1220. In one embodiment, in block 1210 signals are detected from clients within the input streams to determine the client device source of the input stream. In one embodiment, in block 1211, it is determined whether signals are detected or no longer detected from the input streams. In one embodiment, if one or more signals are no longer detected, process 1200 continues to block 1210, otherwise if signals remain detected, process 1200 continues to block 1212.

In one embodiment, in block 1212, the peer coordination device determines which input stream, if eliminated, would yield the best audio fidelity. In one embodiment, process 1200 continues to block 1213, where the peer coordination device coordinates with the peer client devices to cease output of redundant streams. Process 1200 then continues to block 1210.

In one embodiment, in block 1214, the peer coordination device determines which input stream can be restored. In one embodiment, in block 1215, the peer coordination device coordinates with peer client devices to restart appropriate input streams. In one embodiment, process 1200 then returns to block 1210 to continue process 1200.

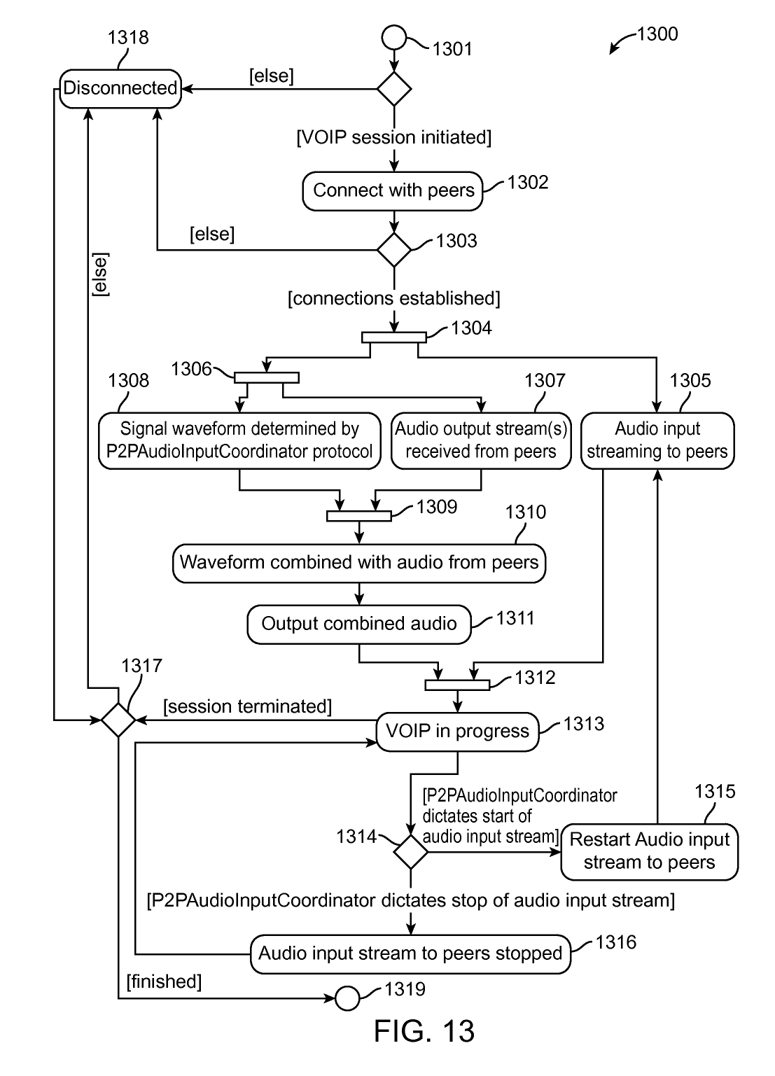

FIG. 13 shows a flow diagram for a client process 1300, according to an embodiment. In one embodiment, client process starts at starting point 1301 where a client device (e.g., client device 800) starts up. In one embodiment, after block 1301 an audio session (e.g., VOIP session, karaoke session, audio recording session, etc.) is initiated between a client device and a peer coordination device (e.g., peer coordination device 1100), otherwise process 1300 continues to block 1318 where the audio session is disconnected (or in a disconnection state). In block 1302, process 1300 connects with peer client devices. In block 1303, the client device determines if connections with the peer client devices are made. If the connections with other client devices were made, process 1300 continues to block 1304, otherwise process 1300 continues to block 1318.

In one embodiment, in block 1304 process 1300 parallel processes to blocks 1305 and 1306. In one embodiment, in block 1305 audio input streams are streamed to peer client devices, and process 1300 continues to block 1312. In one embodiment, in block 1306, process 1300 continues to both blocks 1307 and 1308. In one embodiment, in block 1307 audio output streams are received from peer client devices. In block 1308, a signal waveform is determined by the P2P audio input coordinator module protocol (e.g., from peer coordination device 1100, FIG. 11). In one embodiment, processing continues from blocks 1307 and 1308 to block 1309 for further processing with block 1310.

In one embodiment, in block 1310 a waveform is combined with audio from peer client devices, and the output of combined audio results in block 1311. In one embodiment, in block 1312, after processing of the input streams (from block 1305) and output streams (block 1311) are completed, process 1300 has achieved a status of an audio session in progress at block 1313. In one embodiment, if the client device stops the audio session, process 1300 continues to block 1317 and the process 1300 continues to either block 1318 where the client device is disconnected or to process stop point 1319. In one embodiment, the process 1300 otherwise continues to block 1314 where either the P2P audio input coordinator of the peer coordination device commands start of an audio input stream or commands stopping of an audio input stream.

In one embodiment, if the P2P audio input coordinator of the peer coordination device commands start of an audio input stream, process 1300 continues to block 1315 where audio input is restarted to the peer client devices, and process 1300 continues then to block 1305. In one embodiment, where the P2P audio input coordinator of the peer coordination device commands stopping of an audio input stream, process 1300 continues to block 1316 where audio input streams to peer client devices are stopped, and process 1300 continues to block 1313.

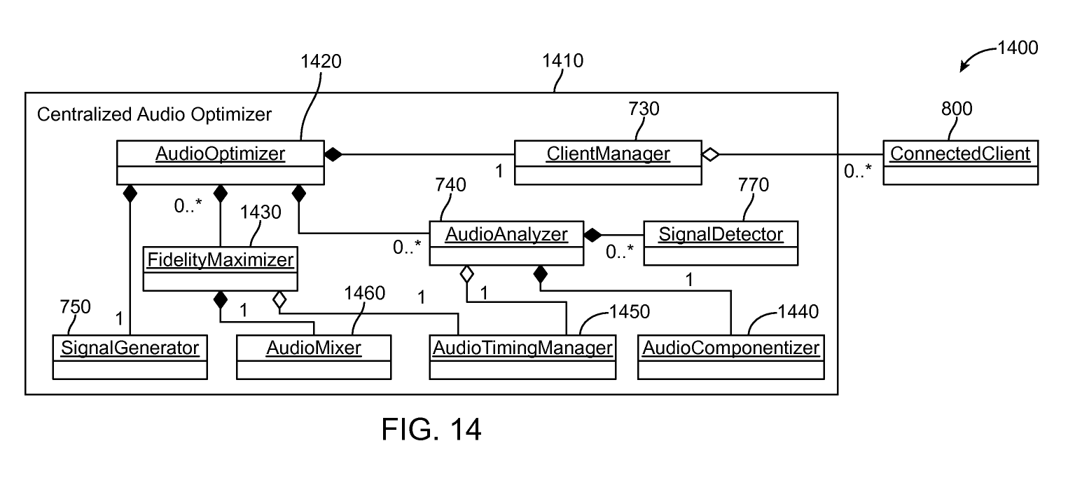

FIG. 14 shows a block diagram of a system 1400 including a centralized optimizer device 1410 and connected client(s) 800, according to an embodiment. In one embodiment, the centralized audio optimizer 1410 includes some of the components similar to the centralized coordinator device 710, such as the client manager module 730, the audio analyzer module 740, the signal generator module 750 and the signal detector module 770. In one embodiment, the centralized optimizer device 1410 also comprises an audio optimizer module 1420 that includes a fidelity maximizer module 1430, an audio componentizer module 1440, an audio timing manager module 1450 and an audio mixer module 1460.

In one embodiment, the centralized audio optimizer device 1410 comprises a centralized component that all client devices connect to upon initiating an audio session (e.g., VOIP session, karaoke session, audio recording session, etc.). In one embodiment, the centralized audio optimizer device 1410 would not terminate redundant client device 800 inputs to enhance audio fidelity, but instead would modify the audio streams that would ultimately be delivered to the peer client devices 800. In one embodiment, the centralized audio optimizer device 1410 performs in real time.

In one embodiment, the audio timing manager module 1450 handles management of audio stream timing to ensure proper stream synchronization during mixing and ultimately client device 800 playback. In one embodiment, the audio componentizer module 1440 is responsible for isolating unique audio components (e.g., distinct audio signals) from each client stream. In one embodiment, the audio analyzer module 740, because the audio optimizer module 1420 controls what should be output from each client device 800, it may use that information to assist the audio analyzer module 740 and the audio componentizer module 1440 in determining the unique components for each device's input stream that is being sent to it. In one embodiment, use of the audio timing manager module 1450 assists the audio analyzer module 740 in further processing and synchronization during optimization.

In one embodiment, the audio mixer module 1460 is moved from the client device 800 to the centralized audio optimizer device 1410. In one embodiment, multiple instances of the fidelity maximizer module 1430 are used to concurrently optimize multiple audio streams from peer client devices 800. In one embodiment, the fidelity maximizer module 1430 uses the audio components, detected signals, and their relative strengths within their respective carrier signals for assembling an optimal audio stream for each client device 800 to output within its respective audible space.

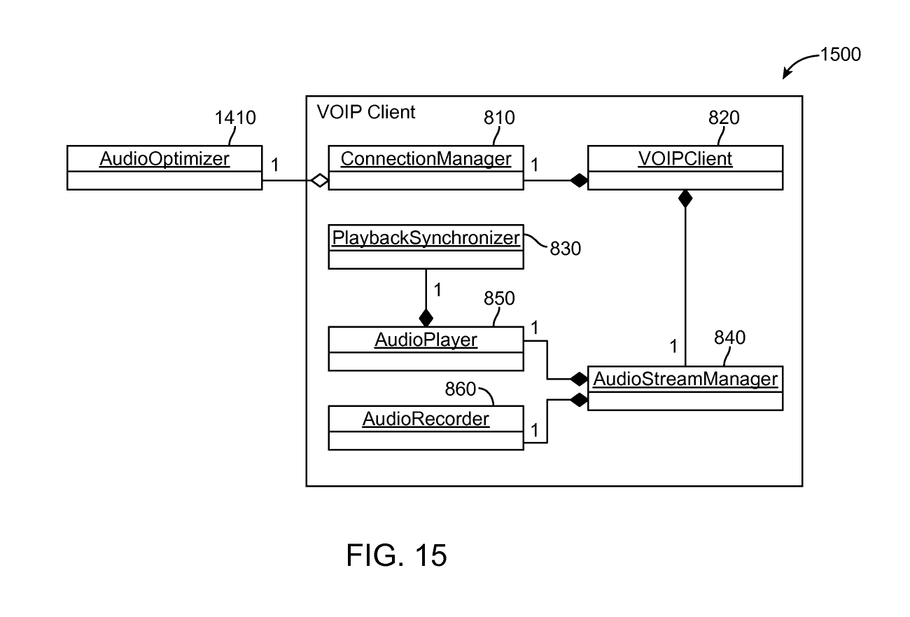

FIG. 15 shows a block diagram for a client device 1500, according to an embodiment. In one embodiment, the client device 1500 is similar to client device 800 (FIG. 8) except the audio mixer module 870 has been removed and is now a component of the centralized audio optimizer device 1410 (as audio mixer module 1460).

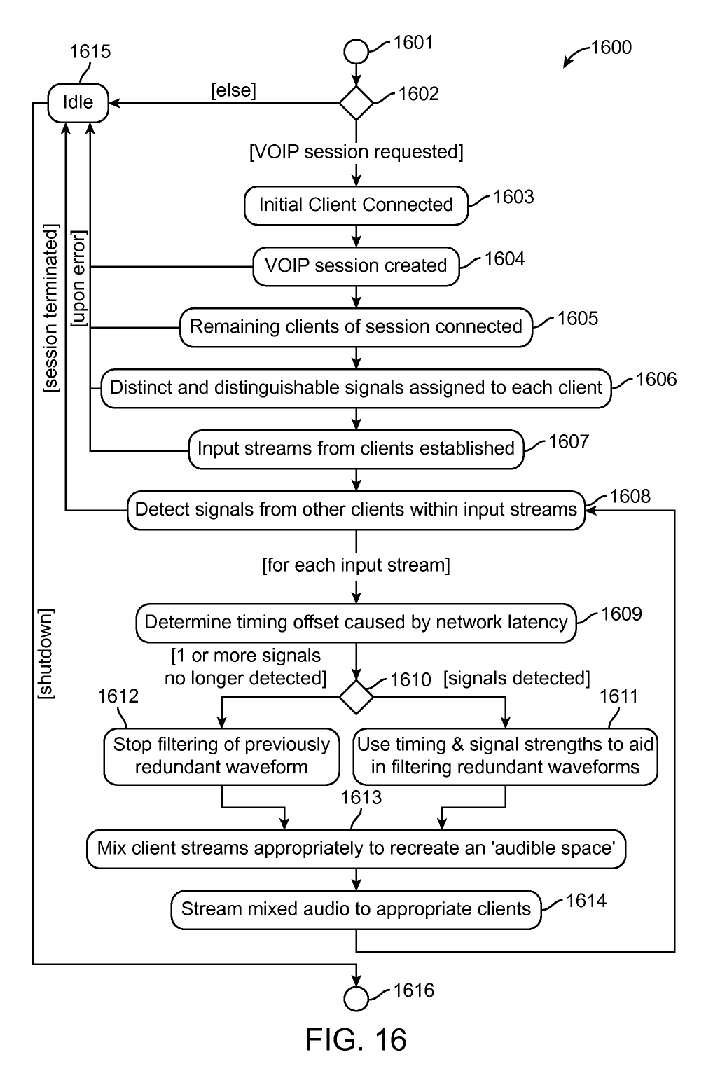

FIG. 16 shows a flow diagram for a centralized optimizer process 1600, according to an embodiment. In one embodiment, the process 1600 starts at starting point 1601 where a centralized optimizer device (e.g., centralized optimizer device 1410) starts up. In one embodiment, after block 1601, in block 1602 it is determined if an audio (e.g., VOIP session, karaoke session, audio recording session, etc.) session has been requested by a peer client device (e.g., peer client device 1500). If it is determined that an audio session has been requested, process 1600 continues to block 1603, otherwise process 1600 continues to block 1615 where the process 1600 remains idle (i.e., waiting for an audio session request), or terminates at stop point 1616 (e.g., after a time period, the centralized optimizer device gets turned/powered off, etc.).

In one embodiment, in block 1603 an initial client device is connected to the centralized optimizer device, otherwise, upon an error (transmission error, device error, etc.) process 1600 continues to block 1615. In one embodiment, in block 1605, any remaining client devices that desire to connect to the audio session are connected by the centralized optimizer device. In one embodiment, if an error occurs connecting a client device, process 1600 continues to block 1615. In one embodiment, process 1600 continues to block 1606 where distinct and distinguishable audio signals are assigned/associated with each connected client device. In one embodiment, if an error occurs, process 1600 continues to block 1615.

In one embodiment, in block 1607 input streams from clients are established. In one embodiment, if an error occurs, process 1600 continues to block 1615. In one embodiment, in block 1608 signals are detected from clients within the input streams to determine the client device source of the input stream. In one embodiment, if an error occurs, process 1600 continues to block 1615. In one embodiment, the centralized optimizer device determines timing offset caused by any network latency.

In one embodiment, in block 1610, it is determined whether signals are detected or no longer detected from the input streams. In one embodiment, if one or more signals are no longer detected, process 1600 continues to block 1612, otherwise if signals remain detected, process 1600 continues to block 1611.

In one embodiment, in block 1611, the centralized optimizer device uses timing and signal strength information to aid in filtering redundant waveforms (i.e., selecting the highest fidelity waveforms). In one embodiment, in block 1612, filtering stops for previously determined redundant waveforms. In one embodiment, process 1600 continues to block 1613 after either blocks 1611 and 1612 are completed.

In one embodiment, in block 1613 client streams are mixed by the audio mixer module of the centralized optimizer device to recreate an ‘audible space.’ In one embodiment, in block 1614 mixed audio streams are streamed to the appropriate client devices. In one embodiment, process 1600 returns to block 1608 to dynamically and continuously continue optimization of audio signal coordination.

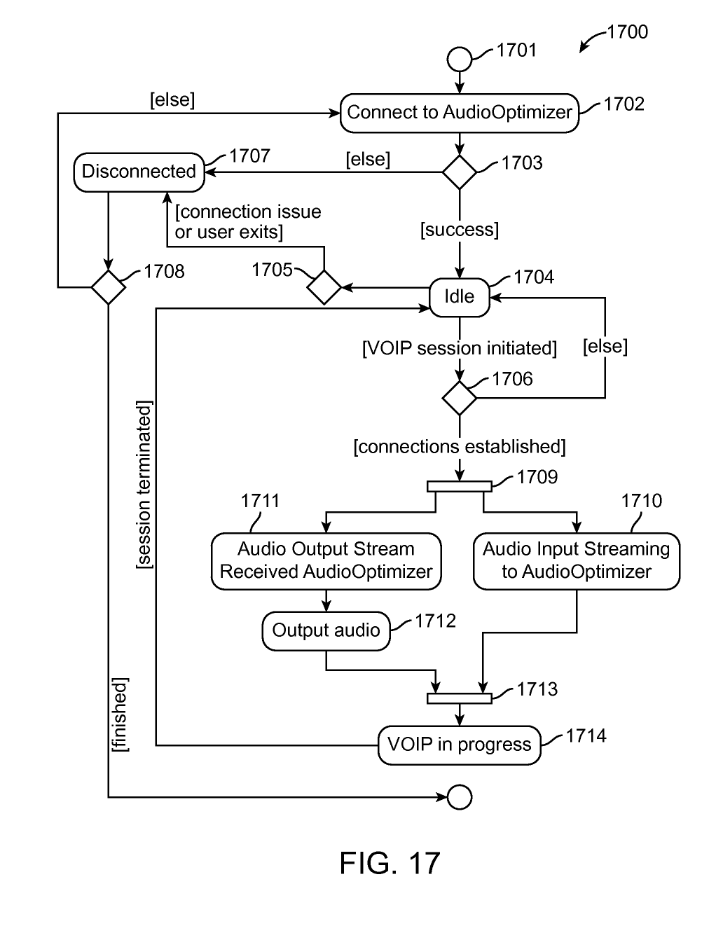

FIG. 17 shows a flow diagram for a client process 1700, according to an embodiment. In one embodiment, the process 1700 starts at starting point 1701 where a client device (e.g., client device 1500, FIG. 15) starts up. In one embodiment, after block 1701, in block 1702 the client device connects to the centralized audio optimizer device (e.g., centralized optimizer device 1410, FIG. 14).

In one embodiment, in block 1703 it is determined if the client device has successfully connected to the centralized optimizer device or not. If it is determined that the client device has successfully connected to the centralized optimizer, process 1700 continues to block 1704, otherwise process 1700 continues to block 1707. In one embodiment, in block 1707 the client device is disconnected and in block 1708 either attempts to connect to the centralized optimizer device in block 1702 or the process 1700 stops processing. In one embodiment, in block 1704 the client device is idle after the audio session is initiated and waits for the centralized optimizer device to process input/output streams. In block 1706 it is determined whether the audio session connection is established or not. If the audio session connection is established, process 1700 continues to block 1709 where process 1700 parallel processes to blocks 1710 and 1711. Otherwise, process 1700 continues to block 1704.

In one embodiment, in block 1710 audio input is streamed to the centralized optimizer device and process 1700 then continues to block 1713. In block 1711, audio output streams are received from the centralized audio optimizer device and then audio is output in block 1712. Process 1700 then continues to block 1713. In one embodiment, process 1700 continues from block 1713 to block 1714 where an audio session is currently in progress. In one embodiment, process 1700 continues to block 1704.

One or more embodiments, define the ‘audible space’ not for reproducing the audio in a spatially relevant way, rather for simply identifying if any device may detect output from any other device in the system. One or more embodiments provide echo cancellation at a system wide level, involving the coordination and potential manipulation of the inputs and outputs to multiple devices, not just a single device. One or more embodiments may work in conjunction with or on top of any other echo cancellation technologies that exist at the device level, which provides an advantage in that the embodiments explicitly address the issues arising from multiple devices feeding extraneous signals to one another in close proximity. One or more embodiments enable multiple and varied client devices, which may be mobile, to be within proximity of one another without interfering in the intelligible quality of sound intended to be output by the system for the reception by users of those devices.

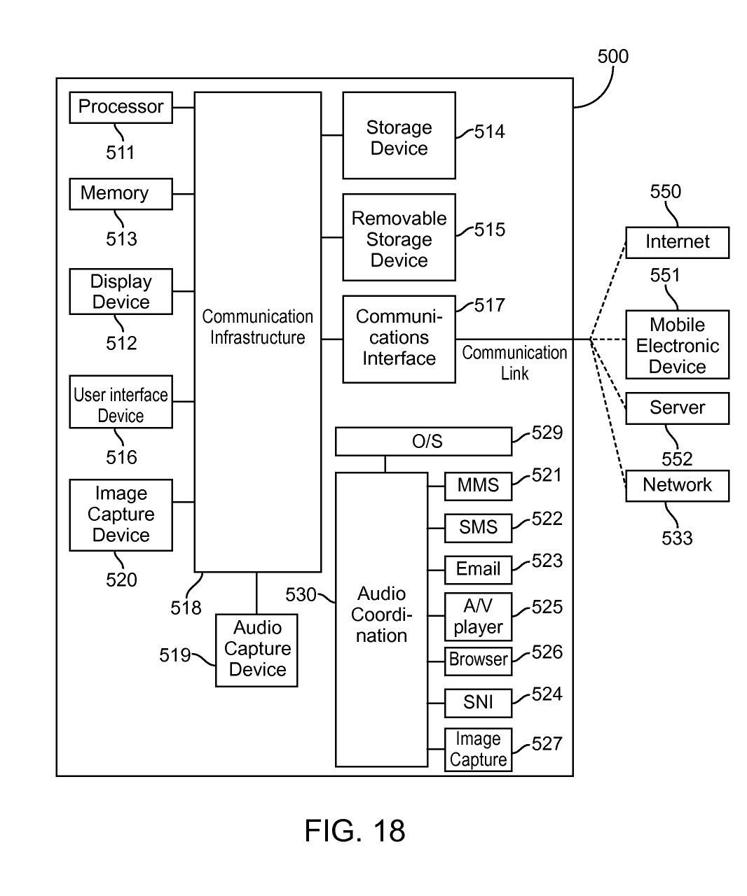

FIG. 18 is a high-level block diagram showing an information processing system comprising a computing system 500 implementing one or more embodiments. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of one or more embodiments in a mobile wireless device such as a mobile phone, the system 500 further includes an image capture device 520, such as a camera 128 (FIG. 2), and an audio capture device 519, such as a microphone 122 (FIG. 2). The system 500 may further include application modules as MMS module 521, SMS module 522, email module 523, social network interface (SNI) module 524, audio/video (AV) player 525, web browser 526, image capture module 527, etc.

In one embodiment, audio coordination processes 530 along with an operating system 529 may be implemented as executable code residing in a memory of the system 500. In another embodiment, such modules may be provided in hardware, firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. A method for audio coordination, comprising:
connecting a plurality of electronic devices to a communication session;
assigning distinct signals to each of the plurality of electronic devices;
establishing input streams from one or more of the plurality of electronic devices;
detecting signals within the input streams; and
selecting one or more electronic devices for eliminating input streams based on an audio fidelity threshold.

2. The method of claim 1, further comprising signaling the selected one or more electronic devices to terminate input streams to other electronic devices.

3. The method of claim 1, further comprising coordinating with the plurality of electronic devices to terminate redundant input streams.

4. The method of claim 1, further comprising:
determining timing offset based on network latency;
adjusting and filtering redundant waveforms of detected signals in input streams based on the determined timing offset and determined signal strength to compensate for the latency;
mixing input streams for recreating an audible space; and
streaming the mixed input streams to one or more of the plurality of electronic devices.

5. The method of claim 4, further comprising:
determining if one or more previously detected signals within input streams are currently undetected; and
ceasing filtering of previously filtered redundant waveforms.

6. The method of claim 1, wherein the audio fidelity threshold is based on detected signal strength.

7. The method of claim 1, wherein one or more of the plurality of electronic devices coordinates elimination of input streams based on the audio fidelity threshold.

8. The method of claim 1, wherein a centralized coordinator coordinates elimination of input streams based on the audio fidelity threshold and manages network connections to the plurality of electronic devices.

9. The method of claim 1, wherein the communication session is one of a voice over Internet protocol (VOIP) session, a karaoke session or an audio recording session.

10. The method of claim 1, further comprising:
combining multiple waveforms for audio output from one or more electronic devices.

11. The method of claim 1, wherein one or more of the plurality of electronic devices are mobile electronic devices.

12. An apparatus comprising:
a coordinator device that manages audio input for a plurality of connected client devices, the coordinator device comprising:
a signal generator that generates and associates a distinct waveform for each connected client device;
a signal detector that detects signal power and waveforms present within audio streams from the plurality of client devices;
a signal analyzer that analyzes the detected waveforms and determines a particular client device that transmitted a detected waveform based on an associated waveform for the particular client device; and
an input signal selector that selects one or more client devices to cease streaming input to peer client devices based on audio fidelity.

13. The apparatus of claim 12, wherein the coordinator device coordinates with the plurality of connected client devices to terminate redundant input streams.

14. The apparatus of claim 13, wherein the coordinator device determines a timing offset based on network latency, filters redundant waveforms of detected signals in input streams based on the determined timing offset and determined signal strength, mixes input streams for recreating an audible space, and streams the mixed input streams to one or more of the plurality of connected client devices.

15. The apparatus of claim 14, wherein the signal detector determines if one or more previously detected signals within input streams are currently undetected, and the input signal selector ceases filtering of previously filtered redundant waveforms.

16. The apparatus of claim 12, wherein the input signal selector determines one or more client devices to cease streaming input to peer client devices using an audio fidelity threshold based on detected signal strength.

17. The apparatus of claim 12, wherein the plurality of connected client devices are connected to one of a voice over Internet protocol (VOIP) session, a karaoke session or an audio recording session.

18. The apparatus of claim 12, wherein the coordinator device combines multiple waveforms for audio output from one or more connected client devices.

19. The apparatus of claim 12, wherein one or more of the plurality of connected client devices are mobile electronic devices.

20. A client device comprising:
a connection manager that manages connections to one or more peer devices joined in a communication session;
a stream manager that manages audio streams including preparing audio streams for transmission or output;
a mixer that combines multiple audio streams into a single audio stream; and
a synchronizer that uses timing information embedded within the audio streams sent from other peer devices for synchronizing playback of the audio streams and increasing audio fidelity within an audible space for peer devices within close proximity to one another.

21. The client device of claim 20, further comprising:
a recorder that provides the audio input stream; and
a player that outputs audio streams and uses the synchronizer to coordinate with peer devices within the audible space.

22. The client device of claim 21, wherein each peer device is assigned a distinct signal by a coordinator device, wherein the coordinator device comprises one of a central coordinator device and a coordinator client device, wherein the assigned distinct signals are used for determining a particular peer device that transmitted a waveform.

23. The client device of claim 22, wherein the communication session comprises one of a voice over Internet protocol (VOIP) session, a karaoke session or an audio recording session.

24. The client device of claim 23, wherein the client device coordinates with peer devices to terminate redundant input streams.

25. The client device of claim 24, wherein the coordinator device determines timing offset based on network latency, filters redundant waveforms of detected signals in input streams based on the determined timing offset and determined signal strength, mixes input streams for recreating an audible space and streams the mixed input streams to one or more of the peer devices.

26. The client device of claim 25, wherein the coordinator device determines if one or more previously detected signals within input streams are currently undetected, and ceases filtering of previously filtered redundant waveforms.

27. The client device of claim 26, wherein one or more of the peer devices coordinates elimination of input streams based on an audio fidelity threshold, and the coordinator device combines multiple waveforms for audio output from one or more peer devices.

28. A non-transitory computer-readable medium having instructions which when executed on a computer perform a method comprising:
connecting a plurality of electronic devices to a communication session;
assigning distinct signals to each of the plurality of electronic devices;
establishing input streams from one or more of the plurality of electronic devices;
detecting signals within the input streams; and
selecting one or more electronic devices for eliminating input streams based on an audio fidelity threshold.

29. The medium of claim 28, further comprising:
signaling the selected one or more electronic devices to terminate input streams to other electronic devices; and
coordinating with the plurality of electronic devices to terminate redundant input streams.

30. The medium of claim 29, further comprising:
determining timing offset based on network latency;
filtering redundant waveforms of detected signals in input streams based on the determined timing offset and determined signal strength;
mixing input streams for recreating an audible space;
streaming the mixed input streams to one or more of the plurality of electronic devices;
determining if one or more previously detected signals within input streams are currently undetected; and
ceasing filtering of previously filtered redundant waveforms.
